(19) United States
(12) Patent Application Publication
(10) Pub. No.: US 2025/0370473 A1
(43) Pub. Date: Dec. 4, 2025

(54) MULTI-MOBILE VEHICLE CONTROL SYSTEM AND METHOD

(71) Applicant: INDUSTRIAL TECHNOLOGY RESEARCH INSTITUTE, Hsinchu (TW)

(72) Inventors: Chun-Sheng WANG, Nantou City (TW); Chao-Wen YANG, Kaohsiung City (TW)

(73) Assignee: INDUSTRIAL TECHNOLOGY RESEARCH INSTITUTE, Hsinchu (TW)

(21) Appl. No.: 18/798,491

(22) Filed: Aug. 8, 2024

(30) Foreign Application Priority Data
May 31, 2024 (TW) 113120329
May 31, 2024 (TW) 113120340

(51) Int. Cl. G05D 1/644; G05D 1/693; G05D 101/00

(52) U.S. Cl. CPC G05D 1/644; G05D 1/693; G05D 2101/22

(57) ABSTRACT

A multi-vehicle control system and method are disclosed. A plurality of transportation costs for a plurality of standby mobile vehicles to reach a target point are calculated. A target standby mobile vehicle with a minimum transportation cost is selected from the standby mobile vehicles that have been determined to have a path. A task is assigned to the target standby mobile vehicle with the minimum transportation cost, and the target standby mobile vehicle is controlled to move to the target point.

This application claims the benefit of Taiwan Patent application Serial No. 113120329, filed May 31, 2024 and No. 113120340, filed May 31, 2024, the disclosure of which are incorporated by reference herein in its entirety.

### TECHNICAL FIELD

The disclosure relates in general to a multi-mobile vehicle control system and method.

### BACKGROUND

In automated fields requiring mobile vehicles (e.g., but not limited to, mobile robots, Automated Guided Vehicles (AGV), Autonomous Mobile Robots (AMR), Automated Guided Forklifts (AGF), etc.), such as semiconductor factories, machine processing factories, logistics warehouses, industrial assembly, and more, the current industry demand is to improve transportation efficiency and avoid traffic congestion. In these applications, it is crucial to effectively dispatch and coordinate the operations of multi-mobile vehicles to ensure smooth traffic flow and efficient operations. However, as the number of mobile vehicles in the system increases, the complexity of scheduling and coordination also increases. The key is to reasonably allocate transportation tasks to each mobile vehicle and coordinate multi-mobile vehicles to reduce conflicts among them, thereby avoiding deadlock situations and maximizing overall transportation efficiency under the premise of meeting the designated transport capacity.

Generally, multi-mobile vehicle management systems can be divided into centralized management and decentralized management.

### SUMMARY

According to one embodiment, a multi-mobile vehicle control method is provided. The multi-mobile vehicle control method comprises: calculating a plurality of transportation costs for a plurality of standby mobile vehicles to reach a target point; selecting a target standby mobile vehicle with a minimum transportation cost from the standby mobile vehicles that have been determined to have a path; and assigning a task to the target standby mobile vehicle with the minimum transportation cost, and controlling the target standby mobile vehicle to move to the target point.

According to another embodiment, a multi-mobile vehicle control method is provided. The multi-mobile vehicle control method comprises: updating an actual exit time of a mobile vehicle from a current path unit, and compensating a time difference between the actual exit time and a planned exit time in a scheduled path timing of the mobile vehicle in a path server; and controlling the mobile vehicle to move along a planned path to a target node.

According to an alternative embodiment, a multi-mobile vehicle control system is provided. The multi-mobile vehicle control system comprises: a path server; a control unit communicating with the path server; and a plurality of mobile vehicles communicating with the path server and the control unit. The path server stores multiple entry-exit timing of each of the mobile vehicles on each path unit. The control unit is configured for: calculating a plurality of transportation costs for a plurality of standby mobile vehicles to reach a target point; selecting a target standby mobile vehicle with a minimum transportation cost from the standby mobile vehicles that have been determined to have a path; and assigning a task to the target standby mobile vehicle with the minimum transportation cost, and controlling the target standby mobile vehicle to move to the target point.

### BRIEF DESCRIPTION OF THE DRAWINGS

FIG. 1 illustrates a schematic diagram of a multi-mobile vehicle control method according to an embodiment of the present application.

FIGS. 2A to 2C respectively show functional block diagrams of a multi-mobile vehicle control system according to different embodiments of the present application.

FIG. 3 shows a site map according to one embodiment of the present application.

FIGS. 4A to 4G show traffic path planning with multi-mobile vehicle scheduling optimization according to one embodiment of the present application.

FIGS. 5A to 5E illustrate the traffic path planning for minimum transport cost according to one embodiment of the present application.

FIGS. 6A to 6C show flowcharts of the traffic path planning method according to one embodiment of the present application.

FIG. 7 shows an example of the optimal assignment method of multi-mobile vehicles according to one embodiment of the present application.

FIG. 8 shows an example of the optimal assignment of multi-mobile vehicles according to one embodiment of the present application.

FIGS. 9A and 9B illustrate the traffic path movement for multi-mobile vehicles according to one embodiment of the present application.

FIGS. 10A and 10B show flowcharts of the traffic path movement method for multi-mobile vehicles according to one embodiment of the present application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

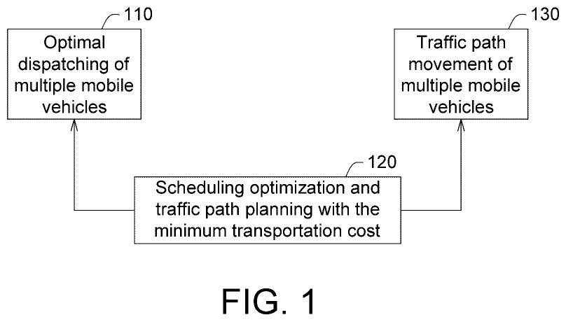

FIG. 1 illustrates a schematic diagram of a multi-mobile vehicle control method according to an embodiment of the present application. In the multi-mobile vehicle control method, the following steps are performed: optimal dispatching of multi-mobile vehicles 110, scheduling optimization and traffic path planning with the minimum transportation cost 120, and traffic path movement of multi-mobile vehicles 130. Therefore, the multi-mobile vehicle control method of this embodiment can optimize system transportation costs (reducing traffic complexity) and avoid traffic congestion. The details of the steps of optimal dispatching of multi-mobile vehicles 110, scheduling optimization and traffic path planning with the minimum transportation cost 120, and traffic path movement of multi-mobile vehicles 130 will be explained below.

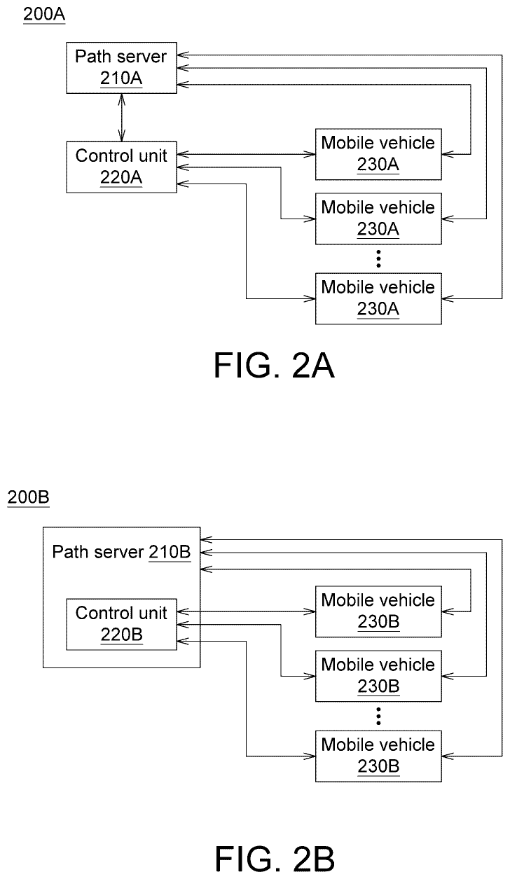

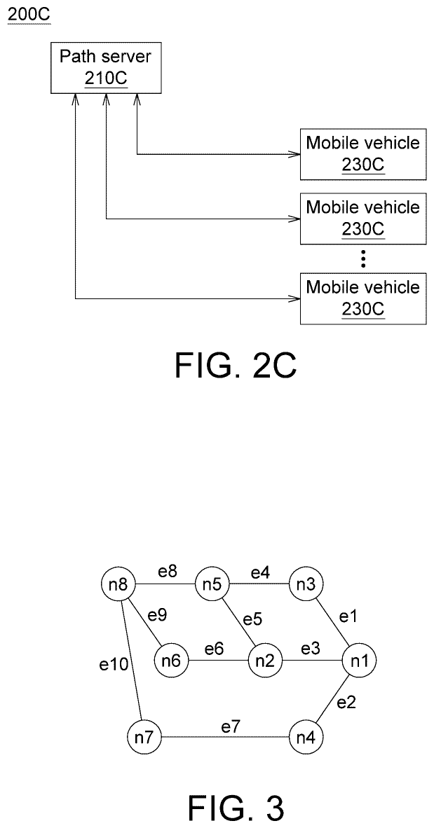

FIGS. 2A to 2C respectively show functional block diagrams of a multi-mobile vehicle control system according to different embodiments of the present application. The multi-mobile vehicle control system 200A includes a path server 210A, a control unit 220A, and multi-mobile vehicles 230A. The path server 210A, control unit 220A, and the mobile vehicles 230A communicate with each other.

Similarly, as shown in FIG. 2B, the multi-mobile vehicle control system 200B includes a path server 210B and multi-mobile vehicles 230B. The path server 210B includes a control unit 220B. The path server 210B, the control unit 220B, and the mobile vehicles 230B communicate with each other.

Similarly, as shown in FIG. 2C, the multi-mobile vehicle control system 200C includes a path server 210C and multi-mobile vehicles 230C. The path server 210C has the functions of a control unit. The path server 210C and the mobile vehicles 230C communicate with each other.

The path servers 210A, 210B, and 210C may be, for example, but not limited to, cloud servers with databases. The path servers 210A, 210B, and 210C store the entry and exit schedules (i.e., entry times and exit times) of each mobile vehicle 230A, 230B, and 230C at each path unit and starting node (or target node). The path units include edges and nodes.

The control units 220A and 220B can be implemented, for example, by using a chip, a circuit block within a chip, a firmware circuit, a circuit board containing several electronic components and wires. Alternatively, the control units 220A and 220B can be implemented by related software or programs executable on a computer system or server. All of these fall within the spirit and scope of the present application.

That is, in an embodiment of the present application, the control unit can be independent of the path server, or the control unit can be integrated into the path server, all within the spirit and scope of the present application.

The mobile vehicles 230A, 230B, and 230C may be, for example, but not limited to, mobile robots, Automated Guided Vehicles (AGV), etc. The mobile vehicles 230A, 230B, and 230C are hardware devices. In other embodiments, the mobile vehicles 230A, 230B, and 230C can obtain the move paths and schedules of other mobile vehicles from the path servers 210A, 210B, and 210C.

In one embodiment of the present application, the path servers 210A to 210C (and control units 220A or 220B) execute any of the following, or any combination thereof, as part of this embodiment: (1) traffic path planning with multi-mobile vehicle scheduling optimization, (2) traffic path planning with the minimum transportation cost, (3) optimal dispatching (or assignment) of multi-mobile vehicles, (4) traffic path movement of multi-mobile vehicles.

In another embodiment of the present application, the path servers 210A to 210C (and control units 220A or 220B) execute (3) the optimal dispatching of multi-mobile vehicles; and the mobile vehicles 230A, 230B, or 230C execute any of the following, or any combination thereof, as part of this embodiment: (1) traffic path planning with multi-mobile vehicle scheduling optimization, (2) traffic path planning with the minimum transportation cost, (4) traffic path movement of multi-mobile vehicles.

In the embodiment of the present application, when implementing the above features, a site map will be constructed. The site map includes multiple nodes and multiple edges, where the connection points between edges are nodes. Below, a path includes at least one path unit and at least one node (which may be a starting node or a target node). A path unit includes an edge and a node.

FIG. 3 shows a site map according to one embodiment of the present application. In FIG. 3, the site map includes nodes n1 to n8 and edges e1 to e10. For example, edge e1 connects nodes n1 and n3, and so on.

The following sections will explain how the present application executes (1) traffic path planning with multi-mobile vehicle scheduling optimization, (2) traffic path planning with the minimum transportation cost, (3) optimal dispatching of multi-mobile vehicles, (4) traffic path movement of multi-mobile vehicles.
(1) Traffic path planning with multi-mobile vehicle scheduling optimization is described.

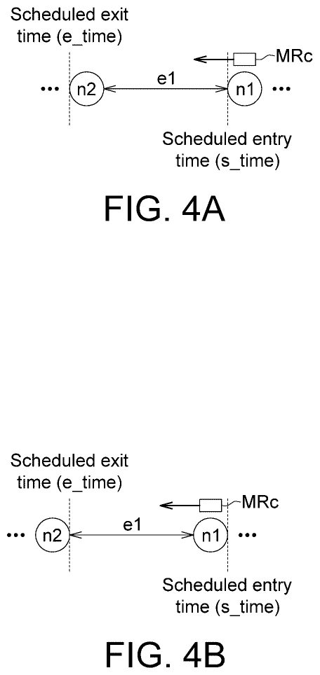

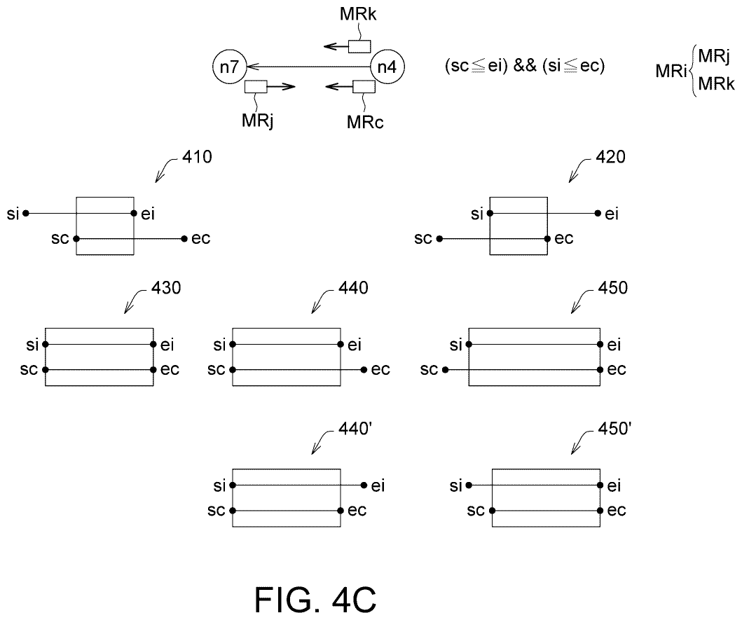

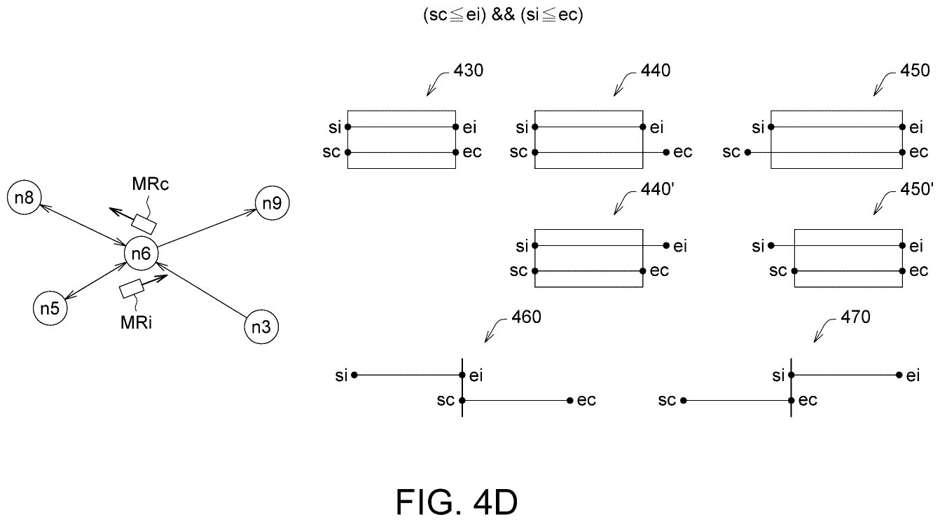

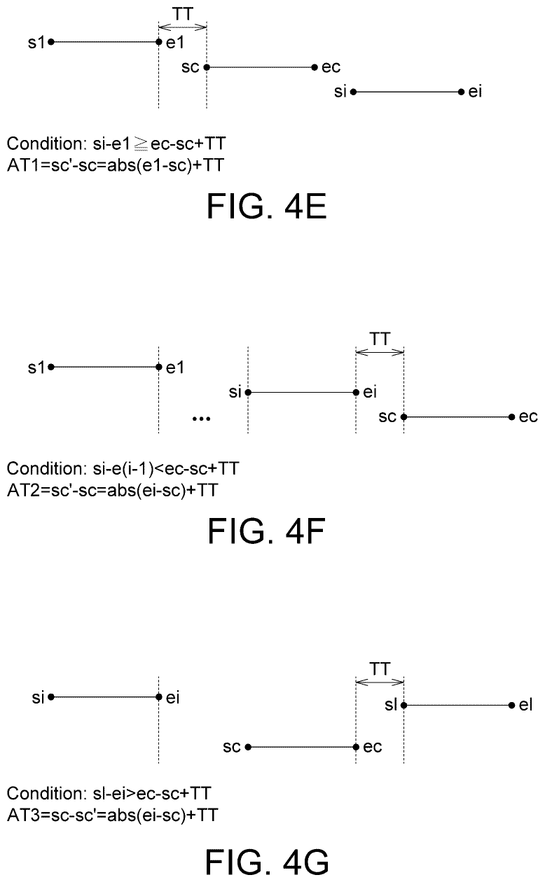

FIGS. 4A to 4G show traffic path planning with multi-mobile vehicle scheduling optimization according to one embodiment of the present application.

FIGS. 4A and 4B show the scheduled entry time (s_time) and the scheduled exit time (e_time) of a path unit according to one embodiment of the present application. In FIG. 4A, the path unit includes edge e1 and node n2. In FIG. 4B, the path unit includes node n2 and edge e1. For instance, in FIG. 3, assuming the planned path starts at node n1 and the target node is n8. In FIG. 4A, the planned path includes: (starting) node n1 and three path units, where the first path unit includes edge e1 and node n3, the second path unit includes edge e4 and node n5, and the third path unit includes edge e8 and node n8. In FIG. 4B, the planned path includes three path units and the (target) node n8, where the first path unit includes node n1 and edge e1, the second path unit includes node n3 and edge e4, and the third path unit includes node n5 and edge e8.

In FIGS. 4A and 4B, the entry time of mobile vehicle MRc into the path unit is considered the scheduled entry time (s_time) of the path unit, and the exit time of mobile vehicle MRc from the path unit is considered the scheduled exit time (e_time) of the path unit.

FIGS. 4C and 4D show the multi-mobile vehicle scheduling overlap determination (i.e., multi-mobile vehicle conflict determination) according to one embodiment of the present application.

In FIGS. 4C and 4D, sc represents the entry time of the mobile vehicle MRc into the path unit, and ec represents the exit time of the mobile vehicle MRc from the path unit. si represents the entry time of another mobile vehicle MRi into the path unit, and ei represents the exit time of the other mobile vehicle MRi from the path unit. If the path unit is occupied by the current mobile vehicle, other mobile vehicles cannot enter. Conversely, if the path unit is occupied by another mobile vehicle, the current mobile vehicle cannot enter. In FIG. 4C, mobile vehicles MRj and MRc face a head-on conflict, while mobile vehicles MRK and MRc face a same-direction conflict. Here, mobile vehicle MRi encompasses both mobile vehicles MRj and MRk.

In one embodiment of the present application, a conflict between multi-mobile vehicles within the same path unit is determined to occur when (sc≤ei) and (si≤ec). In other words, a multi-mobile vehicle conflict is determined to be present when “the entry time sc of the mobile vehicle MRc into the path unit is less than or equal to the exit time ei of another mobile vehicle MRi from the path unit” and “the entry time si of another mobile vehicle MRi into the path unit is less than or equal to the exit time ec of the mobile vehicle MRc from the path unit.”

FIG. 4C shows conflict situations 410 to 450′. For example, in conflict situation 410, a multi-mobile vehicle path unit conflict occurs when, in the original plan, the mobile vehicle MRc attempts to enter the path unit before the other mobile vehicle MRi has exited. Similarly, in conflict situation 420, a multi-mobile vehicle path unit conflict occurs when, in the original plan, the other mobile vehicle MRi attempts to enter the path unit before the mobile vehicle MRc has exited. In conflict situation 430, a multi-mobile vehicle path unit conflict occurs when the entry and exit times of the mobile vehicle MRc and the other mobile vehicle MRi are identical (si=sc and ei=ec). The same principle applies to other conflict situations from 430 to 450′. Specifically, conflicts can occur when the entry times of the mobile vehicle MRc and another mobile vehicle MRi into the path unit are identical, or when the exit times of the mobile vehicle MRc and another mobile vehicle MRi from the path unit are identical. This is within the spirit of the present application.

FIG. 4D shows conflict situations 430 to 470. The mobile vehicle MRc moves from node n6 to node n8, while another mobile vehicle MRi moves from node n6 to node n9. In conflict situations 430, 440, and 440′, a multi-mobile vehicle path unit conflict occurs when, in the original plan, the entry time into node n6 for both the mobile vehicle MRc and the other mobile vehicle MRi is identical (si=sc). In conflict situations 450 and 450′, a multi-mobile vehicle path unit conflict occurs when, in the original plan, the exit time from node n6 for both the mobile vehicle MRc and the other mobile vehicle MRi is identical (ei=ec). In conflict situation 460, a multi-mobile vehicle path unit conflict occurs when, in the original plan, the entry time of the mobile vehicle MRc into node n6 is identical to the exit time of the other mobile vehicle MRi from node n6 (sc=ei). In conflict situation 470, a multi-mobile vehicle path unit conflict occurs when, in the original plan, the exit time of the mobile vehicle MRc from node n6 is identical to the entry time of the other mobile vehicle MRi into node n6 (ec=si).

Therefore, in one embodiment of the present application, when a conflict occurs between multi-mobile vehicles within the same path unit, multi-mobile vehicle overlap timing adjustment is performed to eliminate the conflict. When performing multi-mobile vehicle overlap timing adjustment, the schedules of all mobile vehicles that have reserved the path are sorted.

FIG. 4E shows how to perform multi-mobile vehicle overlap timing adjustment to eliminate multi-mobile vehicle path unit conflicts. In FIG. 4E, the entry time sc of the mobile vehicle MRc into the path unit is adjusted by an adjustment time AT1 to become sc′ (the adjustment can involve slowing down or pausing in the previous path unit), eliminating the multi-mobile vehicle path unit conflict. When [(si−e1)≥(ec−sc+TT)], the entry time of the mobile vehicle MRc is adjusted by an adjustment time AT1 before entering the path unit to eliminate the multi-mobile vehicle path unit conflict. The adjustment time AT1 for the mobile vehicle MRc is set as AT1=sc′−sc=abs(e1−sc)+TT, where abs(e1−sc) represents the absolute value of (e1−sc), and TT represents the tolerance time.

FIG. 4F shows another way to perform multi-mobile vehicle overlap timing adjustment to eliminate multi-mobile vehicle path unit conflicts. In FIG. 4F, the entry time sc of the mobile vehicle MRc into the path unit is adjusted by an adjustment time AT2 to become sc′ (the adjustment can involve slowing down or pausing in the previous path unit), eliminating the multi-mobile vehicle path unit conflict. When [(si−e(i−1)<(ec−sc+TT)], the entry time of the mobile vehicle MRc is adjusted by an adjustment time AT2 before entering the path unit to eliminate the multi-mobile vehicle path unit conflict. The adjustment time AT2 for the mobile vehicle MRc is set as AT2=sc′−sc=abs(ei−sc)+TT.

FIG. 4G shows how to perform multi-mobile vehicle overlap timing adjustment to eliminate multi-mobile vehicle path unit conflicts. In FIG. 4G, the entry time sc of the mobile vehicle MRc into the path unit is adjusted by an adjustment time AT3 to become sc′ (the adjustment can involve speeding up), eliminating the multi-mobile vehicle path unit conflict. When [(s1−ei)>(ec−sc+TT)], the entry time of the mobile vehicle MRc is adjusted by an adjustment time AT3 before entering the path unit to eliminate the multi-mobile vehicle path unit conflict. The adjustment time AT3 for the mobile vehicle MRc is set as AT3=sc−sc′=abs(ei−sc)+TT.

In other words, in one embodiment of the present application, when a path unit conflict occurs between the mobile vehicle and another mobile vehicle, the planned schedule (entry time) of the mobile vehicle is adjusted to resolve the path unit conflict.

In one embodiment of the present application, traffic path planning with multi-mobile vehicle scheduling optimization helps resolve the shortcomings of conventional techniques, such as known technical drawback 1 (the time-consuming waiting for subsequent mobile vehicles) and known technical drawback 4 (traffic congestion, or even system deadlock).

In one embodiment of the present application, the determination of multi-mobile vehicle conflicts and the adjustment of multi-mobile vehicle timing shown in FIGS. 4A to 4G can be executed by control unit 220A or control unit 220B of path server 210B. In another embodiment of the present application, the determination of multi-mobile vehicle conflicts and the adjustment of multi-mobile vehicle timing shown in FIGS. 4A to 4G can be executed by mobile vehicles 230A, 230B, or 230C.
(2) Traffic path Planning for Minimum Transport Cost is described.

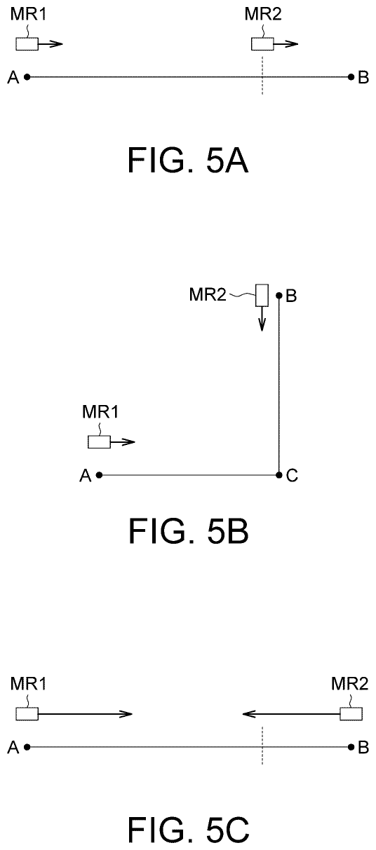

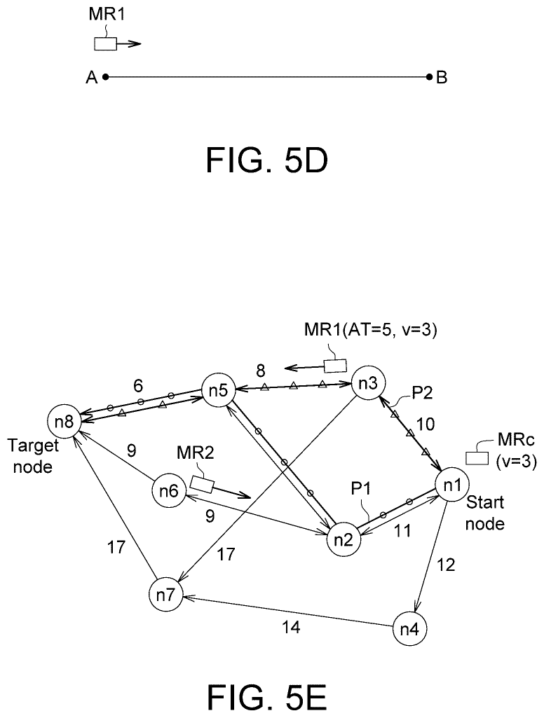

FIGS. 5A to 5E illustrate the traffic path planning for minimum transport cost according to one embodiment of the present application. In these figures, A-C represent nodes. Transport costs include the combined cost of travel path distance, the number of intersections with other mobile vehicles during movement, and the time spent resolving conflicts.

FIG. 5A shows a forward conflict between mobile vehicle MR1 and another mobile vehicle MR2, where the path unit that mobile vehicle MR1 intends to travel and the path unit that mobile vehicle MR2 intends to travel are in the same direction. In the case of a forward conflict, mobile vehicle MR1 waits for mobile vehicle MR2 to leave the path unit before entering it.

When a forward conflict occurs, the adjustment time AT4 for mobile vehicle MR1 is defined as AT4=s1′−s1=abs(e2−s1)+TT. The transport cost for mobile vehicle MR1 is AT4*V+D, where V represents the speed of mobile vehicle MR1, and D represents the distance between two nodes.

FIG. 5B shows a cross conflict between mobile vehicle MR1 and another mobile vehicle MR2, where the path units that mobile vehicle MR1 and mobile vehicle MR2 intend to travel both reach the same node C. In the case of a cross conflict, mobile vehicle MR1 waits for mobile vehicle MR2 to leave the path unit before mobile vehicle MR1 travelling.

When a cross conflict occurs, the adjustment time AT5 for mobile vehicle MR1 is defined as AT5=s1′−s1=abs(e2−s1)+TT, and the transport cost for mobile vehicle MR1 is AT5*V+D.

FIG. 5C shows a head-on conflict between mobile vehicle MR1 and another mobile vehicle MR2, where the path unit that mobile vehicle MR1 intends to travel and the path unit that mobile vehicle MR2 intends to travel are in opposite directions. In the case of a head-on conflict, the adjustment time for mobile vehicle MR1 is such that the transport cost of traveling the conflicting path unit is greater than the transport cost of traveling an adjacent path unit (thus avoiding the conflicting segment), or the adjustment time for mobile vehicle MR1 is infinite. When a head-on conflict occurs, an alternative route is chosen for mobile vehicle MR1.

FIG. 5D shows no conflict. When no conflict occurs, the transport cost for mobile vehicle MR1 is D.

FIG. 5E shows the transport costs of one embodiment of the present application compared to conventional transport costs. Node n1 represents the starting node, and node n8 represents the target node. Mobile vehicle MRc has a speed v of 3. Because another mobile vehicle MR1 is present on the edge from node n3 to node n5, the adjustment time (AT) for mobile vehicle MRc is 5, with a speed v of 3.

In one embodiment of the present application, through traffic path planning for minimum transport cost, the obtained path P1 is from node n1, passing through nodes n2 and n5, to reach node n8. The transport cost of path P1 in this embodiment is 11+13+6=30, and there are no intersections with other mobile vehicles on path P1.

Conversely, in the conventional technique where path planning is based on the shortest distance, the obtained path P2 is from node n1, passing through nodes n3 and n5, to reach node n8. The transport cost of path P2 in the conventional technique is 10+8+3*5+6=39.

Comparing the transport costs of paths P1 and P2 reveals that the traffic path planning in this embodiment achieves the minimum transport cost. This helps address the shortcomings of conventional techniques, namely the time-consuming waiting for subsequent mobile vehicles (Known technical drawback 2) and traffic congestion or even system deadlock (Known technical drawback 4).

In one embodiment of the present application, the traffic path planning for minimum transport cost shown in FIGS. 5A to 5E can be executed by control unit 220A or control unit 220B of path server 210B. In another embodiment of the present application, the traffic path planning for minimum transport cost shown in FIGS. 5A to 5E can be executed by mobile vehicles 230A, 230B, or 230C.

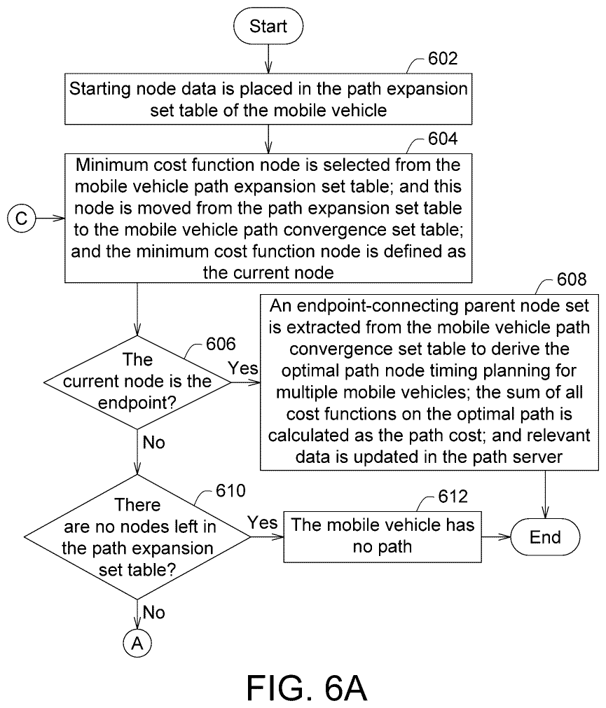

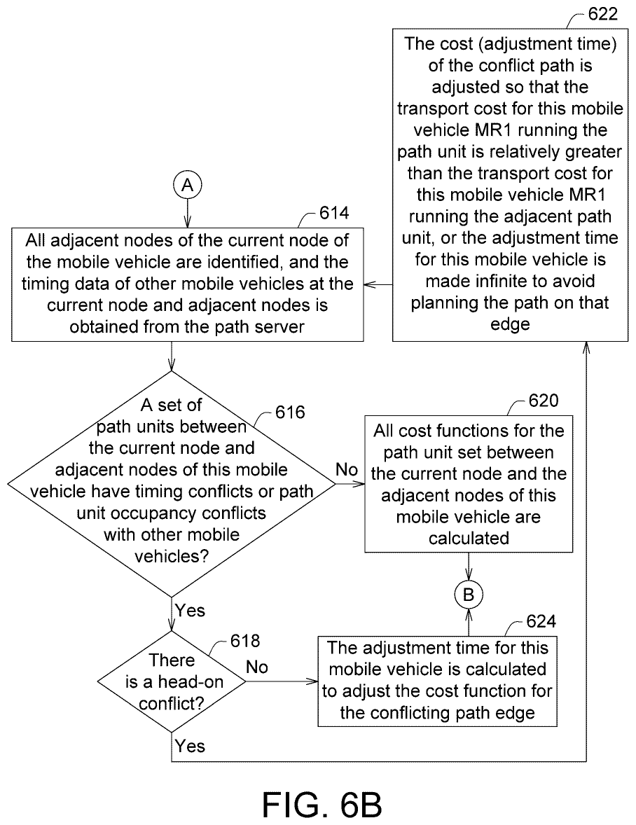

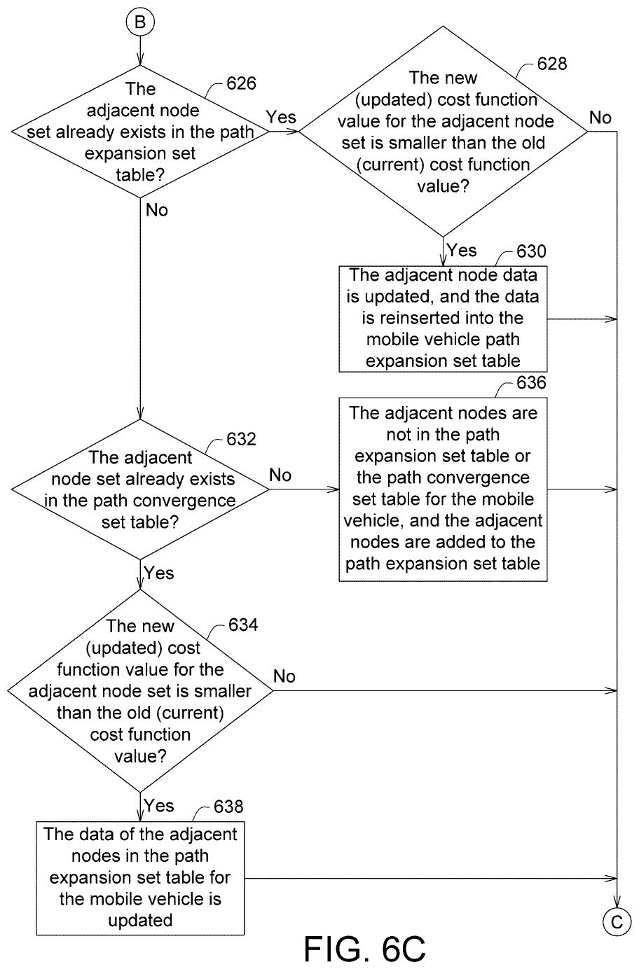

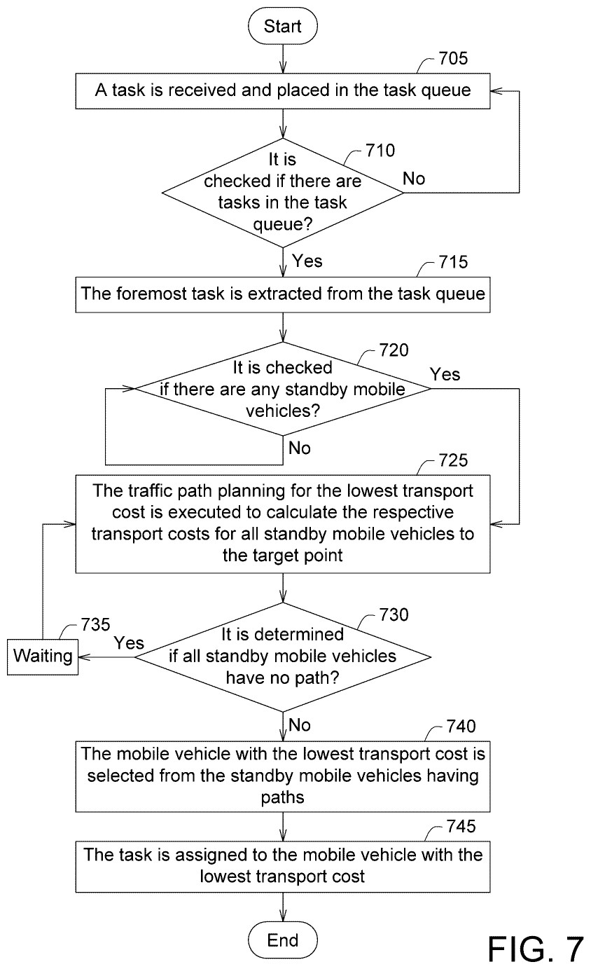

FIGS. 6A to 6C show flowcharts of the traffic path planning method according to one embodiment of the present application. In step 602, starting node data is placed in the path expansion set table (OPEN list) of the mobile vehicle. In step 604, the node with the minimum cost function is selected from the mobile vehicle path expansion set table, and this node is moved from the path expansion set table to the mobile vehicle path convergence set table (CLOSED list). At the same time, the node with the minimum cost function is defined as the current node.

In step 606, it is determined whether the current node is the endpoint. If yes, the process moves to step 608; if no, the process moves to step 610.

In step 608, an endpoint-connecting parent node set is extracted from the mobile vehicle path convergence set table (also referred to as the “path convergence set table”) to derive the optimal path node timing planning for multi-mobile vehicles. The sum of all cost functions on the optimal path is calculated as the path cost, and relevant data is updated in the path server. Step 608 involves traffic path planning for multi-mobile vehicle timing optimization. Here, the terms “path convergence set table” and “path convergence table” have the same meaning, as do “path expansion set table” and “path expansion table.”

In step 610, it is determined whether there are no nodes left in the path expansion set table. If step 610 is affirmative, the process moves to step 612; if negative, the process moves to step 614.

In step 612, it is determined that the mobile vehicle has no path.

In step 614, all adjacent nodes of the current node of the mobile vehicle are identified, and the timing data of other mobile vehicles at the current node and adjacent nodes is obtained from the path server. Step 614 can be executed by the path server and control unit.

In step 616, as described in the traffic path planning for the minimum transport cost with multi-mobile vehicles, it is determined whether a set of path units between the current node and adjacent nodes of this mobile vehicle will have timing conflicts or path unit occupancy conflicts with other mobile vehicles. If step 616 is affirmative, the process proceeds to step 618. If negative, the process proceeds to step 620. Step 616 belongs to the traffic path planning for the minimum transport cost with multi-mobile vehicles. A path unit set refers to a collection of multiple path units.

In step 618, as described in the traffic path planning for the optimization of scheduling multi-mobile vehicles, it is determined whether there is a head-on conflict. If step 618 is affirmative, the process proceeds to step 622. If negative, the process proceeds to step 624. Step 618 belongs to the traffic path planning for the optimization of scheduling multi-mobile vehicles.

In step 620, as described in the traffic path planning for the lowest (minimum) transport cost with multi-mobile vehicles, all cost functions for the path unit set between the current node and the adjacent nodes of this mobile vehicle are calculated. Step 620 belongs to the traffic path planning for the lowest transport cost with multi-mobile vehicles.

In step 622, as described in the traffic path planning for the optimization of scheduling multi-mobile vehicles, the cost (adjustment time) of the conflict path is adjusted so that the transport cost for this mobile vehicle MR1 running the path unit is relatively greater than the transport cost for this mobile vehicle MR1 running the adjacent path unit (thus avoiding running on the conflicting path edge), or the adjustment time for this mobile vehicle is made infinite to avoid planning the path on that edge. Step 622 belongs to the traffic path planning for the optimization of scheduling multi-mobile vehicles.

In step 624, as described in the traffic path planning for the lowest transport cost with multi-mobile vehicles, the adjustment time for this mobile vehicle is calculated to adjust the cost function for the conflicting path edge. Step 624 belongs to the traffic path planning for the lowest transport cost with multi-mobile vehicles.

In step 626, it is determined whether the adjacent node set already exists in the path expansion set table. If step 626 is affirmative, the process proceeds to step 628. If negative, the process proceeds to step 632.

In step 628, it is determined whether the new cost function value for the adjacent node set is smaller than the old cost function value. If step 628 is affirmative, the process proceeds to step 630. If negative, the process returns to step 604.

In step 630, the adjacent node data is updated, and the data is reinserted into the mobile vehicle path expansion set table.

In step 632, it is determined whether the adjacent node set already exists in the path convergence set table. If step 632 is affirmative, the process proceeds to step 634. If negative, the process proceeds to step 636.

In step 634, it is determined whether the new (updated) cost function value for the adjacent node set is smaller than the old (current) cost function value. If step 634 is affirmative, the process proceeds to step 638. If negative, the process returns to step 604.

In step 636, it is determined that the adjacent nodes are not in the path expansion set table or the path convergence set table for the mobile vehicle, and the adjacent nodes are added to the path expansion set table.

In step 638, the data of the adjacent nodes in the path expansion set table for the mobile vehicle is updated.
(3) Optimal Assignment of Multi-mobile vehicles is described.

FIG. 7 shows an example of the optimal assignment method of multi-mobile vehicles according to one embodiment of the present application. The optimal assignment method for multi-mobile vehicles is executed by the control unit 220A or 220B, or the path server 210C.

In step 705, a task is received and placed in the task queue.

In step 710, it is checked if there are tasks in the task queue. If there is no any task in the task queue, the flow returns to step 705. If there is any task in the task queue, the flow proceeds to step 715.

In step 715, the foremost task is extracted from the task queue.

In step 720, it is checked if there are any standby mobile vehicles. If yes in step 720, the flow proceeds to step 725.

In step 725, the traffic path planning for the lowest transport cost is executed to calculate the respective transport costs for all standby mobile vehicles to the target point (i.e., the task starting point). Details of step 725 are shown in FIG. 6A to FIG. 6C.

In step 730, it is determined if all standby mobile vehicles have no path. If yes in step 730, the flow proceeds to step 735. If no in step 730, the flow proceeds to step 740.

In step 735, a waiting period is executed and step 725 is executed again.

In step 740, the mobile vehicle with the lowest transport cost is selected from the standby mobile vehicles having paths.

In step 745, the task is assigned to the mobile vehicle with the lowest transport cost.

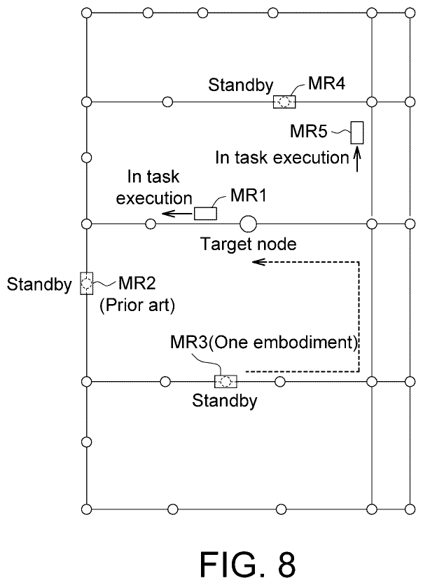

FIG. 8 shows an example of the optimal assignment of multi-mobile vehicles according to one embodiment of the present application. In FIG. 8, mobile vehicles MR1 and MR5 are performing tasks, while mobile vehicles MR2 to MR4 are on standby. In FIG. 8, the target node refers to the starting node of the task to be assigned. After executing the optimal assignment of multi-mobile vehicles in this embodiment, mobile vehicle MR3 is selected. Conversely, in conventional technology, the mobile vehicle MR2 closest to the target node would be chosen, but this selection incurs high transport costs, possibly due to path unit conflicts with other mobile vehicles. However, the transport cost calculation in this embodiment indicates that the transport cost of mobile vehicle MR3 is lower than that of mobile vehicle MR2. Therefore, mobile vehicle MR3 is the better choice. In this embodiment, once mobile vehicle MR3 is selected, the aforementioned optimized scheduling of multi-mobile vehicles, traffic path planning for the lowest transport cost, and traffic path movement methods are used to move mobile vehicle MR3 to the target point.

The optimal assignment method for multi-mobile vehicles in this embodiment can address the drawback of known technology 3 (without considering transport costs, leading to conflicts among multi-mobile vehicles and reduced transport efficiency).
(4) Traffic Path Movement for Multi-mobile vehicles is described.

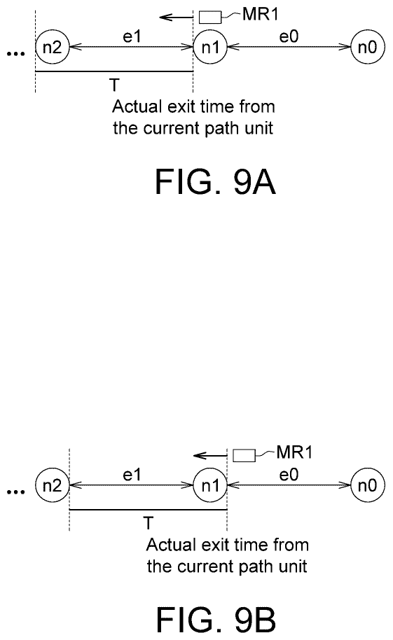

FIGS. 9A and 9B illustrate the traffic path movement for multi-mobile vehicles according to one embodiment of the present application.

FIG. 9A shows a schematic diagram when mobile vehicle MR1 starts to leave the current path unit (including edge e0 and node n1). When the mobile vehicle starts to leave the current path unit, the following steps are performed.
Step 1: Update the actual exit time of the mobile vehicle from the current path unit and compensate the difference between the actual exit time and the planned exit time in the scheduled path timing.
Step 2: If a conflict occurs in the compensated current path unit, re-plan the conflicted current path unit.
Step 3: Occupy the next path unit T (including edge e1 and node n2).
Step 4: Release the current path unit (including edge e0 and node n1), and update the data of the occupied next path unit T (edge (e1) data and node (n2) data) and the released current path unit data (edge (e0) data and node (n1) data) in the path server.

FIG. 9B shows a schematic diagram of the mobile vehicle MR1 entering the current path unit. When the mobile vehicle enters the current path unit, the following steps are performed.
Step 1: Release the previous path unit (edge e0 and node n0).
Step 2: Update the actual entry time of the mobile vehicle into the current path unit and compensate the difference between the actual entry time and the planned entry time in the scheduled path timing.
Step 3: If a conflict occurs in the compensated current path unit, re-plan the conflicted current path unit.
Step 4: Occupy the current path unit T (including edge e1 and node n1), and update the data of the released previous path unit (edge (e0) data, node (n0) data) and the occupied current path unit data (edge (e1) data and node (n1) data) in the path server.

Additionally, in other possible embodiments of the present application, the entry and exit of path units shown in FIGS. 8A and 8B can be mixed and matched, which is also within the spirit and scope of the present application.

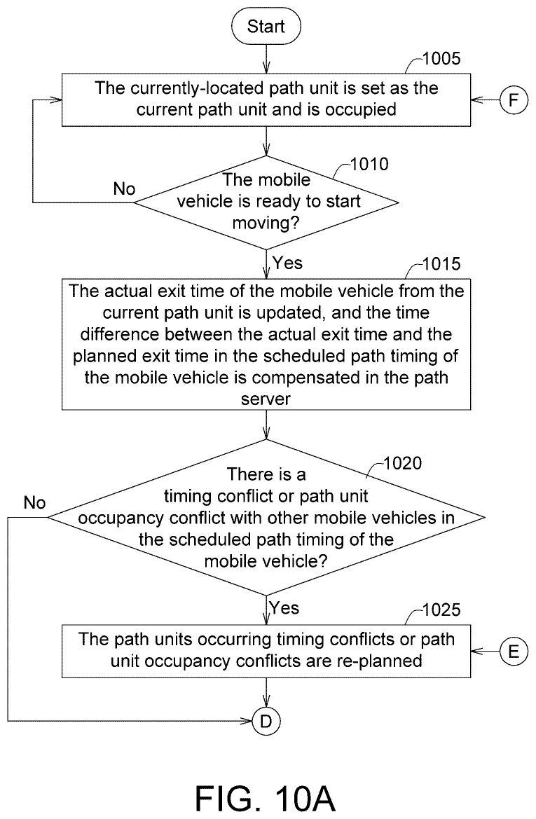

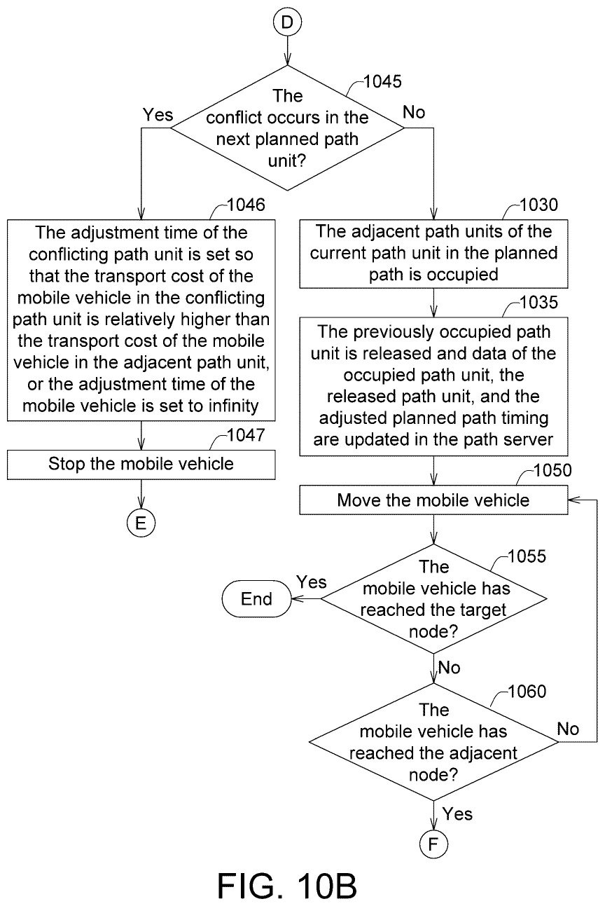

FIGS. 10A and 10B show flowcharts of the traffic path movement method for multi-mobile vehicles according to one embodiment of the present application.

In step 1005, the currently-located path unit is set as the current path unit and is occupied.

In step 1010, it is determined if the mobile vehicle is ready to start moving. If step 1010 is true, the method proceeds to step 1015. If step 1010 is false, the method returns to step 1005.

In step 1015, the actual exit time of the mobile vehicle from the current path unit is updated, and the time difference between the actual exit time and the planned exit time in the scheduled path timing of the mobile vehicle is compensated in the path server. Refer to FIGS. 9A and 9B for details of step 1015.

In step 1020, it is determined if there is a timing conflict or path unit occupancy conflict with other mobile vehicles in the scheduled path timing of the mobile vehicle. If step 1020 is true, the method proceeds to step 1025. If step 1020 is false, the method proceeds to step 1045.

In step 1025, the path units occurring timing conflicts or path unit occupancy conflicts are re-planned.

In step 1045, it is determined if the conflict occurs in the next planned path unit. If step 1045 is true, the method proceeds to steps 1046 and 1047. If step 1045 is false, the method returns to step 1030.

In step 1046, the adjustment time of the conflicting path unit is set so that the transport cost of the mobile vehicle in the conflicting path unit is relatively higher than the transport cost of the mobile vehicle in the adjacent path unit, or the adjustment time of the mobile vehicle is set to infinity. In step 1047, the mobile vehicle is stopped.

In step 1030, the adjacent path units of the current path unit in the planned path is occupied.

In step 1035, the previously occupied path unit is released and data of the occupied path unit, the released path unit, and the adjusted planned path timing are updated in the path server.

After step 1035, the method proceeds to step 1050 to move the mobile vehicle.

In step 1055, it is determined whether the mobile vehicle has reached the target node. If step 1055 is true, the method ends. If step 1055 is false, the method proceeds to step 1060.

In step 1060, it is determined whether the mobile vehicle has reached the adjacent node. If step 1060 is true, the method returns to step 1005. If step 1060 is false, the method returns to step 1055.

In this embodiment, the use of multi-mobile vehicle traffic path movement helps to address several known techniques drawbacks: (1) known techniques drawback 1: time-consuming waiting for subsequent mobile vehicles, (2) known techniques drawback 2: time-consuming waiting, (3) known techniques drawback 3: without consideration of movement costs which can lead to conflicts and decreased efficiency, and (4) known techniques drawback 4: traffic congestion and system deadlock.

In this embodiment, the multi-mobile vehicle traffic path movement depicted in FIGS. 9A, 9B, 10A, and 10B can be executed by the control unit 220A or the control unit 220B of the path server 210B or the path server 210C. In another embodiment, the multi-mobile vehicle traffic path movement depicted in FIGS. 9A, 9B, 10A, and 10B can be executed by the mobile vehicles 230A, 230B, or 230C.

The multi-mobile vehicle control system of this embodiment, combined with methods such as optimal assignment of multi-mobile vehicles, optimization of multi-mobile vehicle scheduling, minimum-cost traffic path planning, and control methods for multi-mobile vehicle traffic path movement, addresses known problems in multi-mobile vehicle systems such as path unit occupation, idle waiting time, and deadlock at intersections, thereby achieving benefits such as avoiding traffic congestion and improving transport efficiency.

While this disclosure may describe many specific details, these should not be construed as limitations on the scope of the claimed invention, but rather as descriptions of specific embodiments. Features described in the context of one embodiment may also be implemented in combination in a single embodiment. Conversely, various features described in the context of one embodiment may also be implemented individually or in any appropriate sub-combination in multiple embodiments. Additionally, while operations may be depicted in a specific order in the drawings, this should not be construed as requiring that the operations must be performed in the specific order or sequence shown, or that all depicted operations must be performed to achieve the desired result.

While the above-described embodiments of the present disclosure only reveal some examples and implementations, various changes, modifications, and enhancements may be made based on the disclosed content.

In some circumstances, the advantage of centralized management is its simple structure and easier implementation; however, the disadvantage is that the information exchange of mobile vehicles must be bridged through the central controller, and processes such as vehicle dispatching and path planning must be calculated by the central controller before transmitting task commands and corresponding move paths to the mobile vehicles. Therefore, when the number of mobile vehicles increases, the central controller maybe prone to system delays due to excessive computation load, which may even lead to system bottlenecks.

Still in some other circumstances, the advantage of decentralized management is that it effectively solves the system delay problem caused by centralized management. Since each mobile vehicle and the central controller are independent entities (agents), they can exchange information with each other, and apart from task dispatching calculations by the central controller, the move path planning is calculated by the mobile vehicles themselves after receiving the dispatched tasks from the central controller. This decentralized architecture, where each entity shares the system planning load, can significantly reduce the computational burden on the central controller. However, the downside of this architecture maybe its relative complexity and the higher cost of implementation and maintenance.

Moreover, considering current mobile vehicle control, there may be several major issues to overcome.
Known technical issue 1: After the optimal path planning for a mobile vehicle, it will occupy the move path. If subsequent mobile vehicles plan the same or overlapping paths, the subsequent mobile vehicles need to wait until the preceding mobile vehicle vacates the path, causing time-consuming delays for the subsequent vehicles.
Known technical issue 2: During path planning, the potential intersection of multi-mobile vehicles is not considered, hence only the shortest distance path is planned, which maybe more likely to result in time-consuming delays.
Known technical issue 3: When assigning tasks, directly assigning the task to the mobile vehicle closest to the target point without considering transport costs could easily lead to conflicts among multi-mobile vehicles, resulting in reduced transport efficiency.
Known technical issue 4: When handling multiple opposing tasks, if the system only plans the shortest distance path, it could easily cause traffic congestion and even lead to system deadlock.

Therefore, the industry currently needs a multi-mobile vehicle control system and method to improve the aforementioned existing drawbacks, enhance transportation efficiency, and avoid traffic congestion.

The present application relates to a multi-mobile vehicle control system and method that optimizes traffic move sequences through path planning with multi-mobile vehicle scheduling optimization, for improving the first known technical issue (if a subsequent mobile vehicle plans the same or overlapping path, the subsequent mobile vehicle must wait for the preceding mobile vehicle to vacate the path, causing time-consuming delays for the subsequent vehicle).

The present application relates to a multi-mobile vehicle control system and method that proposes a multi-mobile vehicle traffic path planning algorithm to achieve the optimal path with the minimum transportation cost. This addresses the second known technical issue (path planning processes do not consider potential intersections of multi-mobile vehicles, thus only planning the shortest distance path, which maybe more likely to result in time-consuming delays).

The present application relates to a multi-mobile vehicle control system and method that proposes an optimal dispatching algorithm for multi-mobile vehicles. This algorithm assigns tasks to the mobile vehicle with the minimum transportation cost. The transportation cost includes the distance of the move path, the number of intersections with other mobile vehicles during movement, and the time spent resolving conflicts. This addresses the third known technical issue (assigning tasks to the mobile vehicle closest to the target point without considering transportation cost could easily lead to conflicts among multi-mobile vehicles, resulting in reduced transportation efficiency).

The present application relates to a multi-mobile vehicle control system and method that combines optimal dispatching of multi-mobile vehicles, scheduling optimization, minimum transportation cost traffic path planning, and multi-mobile vehicle traffic path movement. This approach optimizes system transportation costs (reduces traffic complexity), avoids traffic congestion, and improves upon the fourth known technical issue (only planning the shortest distance path when handling multiple opposing tasks could easily cause traffic congestion and even lead to system deadlock).

In summary, while the present application has been disclosed in exemplary embodiments, it is not limited thereby. Those skilled in the art, within the spirit and scope of the present application, may make various modifications and refinements. Therefore, the protection scope of the present application shall be defined by the appended claims.

What is claimed is:

1. A multi-mobile vehicle control method comprising:
calculating a plurality of transportation costs for a plurality of standby mobile vehicles to reach a target point;
selecting a target standby mobile vehicle with a minimum transportation cost from the standby mobile vehicles that have been determined to have a path; and
assigning a task to the target standby mobile vehicle with the minimum transportation cost, and controlling the target standby mobile vehicle to move to the target point.

2. The multi-mobile vehicle control method according to claim 1, wherein,
when it is determined that all of the standby mobile vehicles have no path, waiting.

3. The multi-mobile vehicle control method according to claim 1, wherein the transportation cost includes: a travel path distance, a number of intersections with other mobile vehicles during movement, and time spent resolving conflicts.

4. The multi-mobile vehicle control method according to claim 1, further comprising:
determining whether the target mobile vehicle and a first mobile vehicle encounter a forward conflict, a head-on conflict, or a cross conflict on a path unit;
when it is determined that the target mobile vehicle and the first mobile vehicle encounter the forward conflict on the path unit, waiting for the first mobile vehicle to leave the path unit before controlling the target mobile vehicle to travel the path unit;
when it is determined that the target mobile vehicle and the first mobile vehicle encounter the head-on conflict on the path unit, selecting an alternative edge for the target mobile vehicle; and
when it is determined that the target mobile vehicle and the first mobile vehicle encounter the cross conflict on the path unit, waiting for the first mobile vehicle to leave the path unit before controlling the target mobile vehicle to travel the path unit.

5. The multi-mobile vehicle control method according to claim 4, wherein,
when the path unit that the target mobile vehicle intends to travel and the path unit that the first mobile vehicle intends to travel are in the same direction, it is determined that the target mobile vehicle and the first mobile vehicle have the forward conflict,
adjusting the entry time point s1 of the target mobile vehicle to an adjusted entry time point s1′, AT4=s1′−s1=abs(e2−s1)+TT,
where e2 is an exit time point of the first mobile vehicle from the path unit, abs(e2−s1) represents an absolute value of (e2−s1), and TT is a tolerance time,
the transportation cost of the target mobile vehicle is AT4*V+D, where V represents a speed of the target mobile vehicle, and D represents a distance between two nodes.

6. The multi-mobile vehicle control method according to claim 4, wherein,
when the path unit that the target mobile vehicle intends to travel and a second path unit that the first mobile vehicle intends to travel reach the same connection point, it is determined that the target mobile vehicle and the first mobile vehicle have the cross conflict,
adjusting the entry time point s1 of the target mobile vehicle to an adjusted entry time point s1′, AT5=s1′−s1=abs(e2−s1)+TT, abs(e2−s1) represents an absolute value of (e2−s1), and TT is a tolerance time,
the transportation cost of the target mobile vehicle is AT5*V+D, where V represents a speed of the target mobile vehicle, and D represents a distance between two nodes.

7. The multi-mobile vehicle control method according to claim 4, wherein,
when the path unit that the target mobile vehicle intends to travel and the path unit that the first mobile vehicle intends to travel are in opposite directions, it is determined that the target mobile vehicle and the first mobile vehicle have the head-on conflict,
when the head-on conflict occurs, an adjustment time for the target mobile vehicle makes the transportation cost for traveling the path unit higher than the transportation cost for traveling an adjacent path unit.

8. The multi-mobile vehicle control method according to claim 4, wherein,
when it is determined that there is no conflict between the target mobile vehicle and the first mobile vehicle, an adjusted transportation cost of the target mobile vehicle is related to a distance between two nodes.

9. A multi-mobile vehicle control method, comprising:
updating an actual exit time of a mobile vehicle from a current path unit, and compensating a time difference between the actual exit time and a planned exit time in a scheduled path timing of the mobile vehicle in a path server; and
controlling the mobile vehicle to move along a planned path to a target node.

10. The multi-mobile vehicle control method according to claim 9, further comprising:
determining whether there is a multi-mobile vehicle conflict or a path unit occupancy conflict with the at least other mobile vehicle in the scheduled path timing of the mobile vehicle; and
replanning the path unit where the multi-mobile vehicle conflict or the path unit occupancy conflict occurs.

11. The multi-mobile vehicle control method according to claim 10, wherein the path unit occupancy conflict includes a forward conflict, a cross conflict, or a head-on conflict.

12. The multi-mobile vehicle control method according to claim 10, wherein, when the mobile vehicle starts to leave the current path unit:
when a conflict occurs in the current path unit after timing compensation, replanning the conflicted current path unit;
occupying a next path unit; and
releasing the current path unit, and updating data of the occupied next path unit and the released current path unit in the path server.

13. The multi-mobile vehicle control method according to claim 10, wherein, when the mobile vehicle starts to enter the current path unit:
releasing a previous path unit;
updating an actual entry time of the mobile vehicle into the current path unit, and compensating a time difference between the actual entry time and a planned entry time in a planned path schedule;
when a conflict occurs in the current path unit after timing compensation, replanning the conflicted current path unit; and
occupying the current path unit, and updating data of the released previous path unit and the occupied current path unit in the path server.

14. A multi-mobile vehicle control system comprising:
a path server;
a control unit communicating with the path server; and
a plurality of mobile vehicles communicating with the path server and the control unit,
wherein the path server stores multiple entry-exit timing of each of the mobile vehicles on each path unit; and
the control unit is configured for:
calculating a plurality of transportation costs for a plurality of standby mobile vehicles to reach a target point;
selecting a target standby mobile vehicle with a minimum transportation cost from the standby mobile vehicles that have been determined to have a path; and
assigning a task to the target standby mobile vehicle with the minimum transportation cost, and controlling the target standby mobile vehicle to move to the target point.

15. The multi-mobile vehicle control system according to claim 14, wherein,
when it is determined that all of the standby mobile vehicles have no path, waiting.

16. The multi-mobile vehicle control system according to claim 14, wherein the transportation cost includes: a travel path distance, a number of intersections with other mobile vehicles during movement, and time spent resolving conflicts.

17. The multi-mobile vehicle control system according to claim 14, wherein the control unit or the mobile vehicles execute are configured for:
determining whether the target mobile vehicle and a first mobile vehicle encounter a forward conflict, a head-on conflict, or a cross conflict on a path unit;
when it is determined that the target mobile vehicle and the first mobile vehicle encounter the forward conflict on the path unit, waiting for the first mobile vehicle to leave the path unit before controlling the target mobile vehicle to travel the path unit;
when it is determined that the target mobile vehicle and the first mobile vehicle encounter the head-on conflict on the path unit, selecting an alternative edge for the target mobile vehicle; and
when it is determined that the target mobile vehicle and the first mobile vehicle encounter the cross conflict on the path unit, waiting for the first mobile vehicle to leave the path unit before controlling the target mobile vehicle to travel the path unit.

18. The multi-mobile vehicle control system according to claim 17, wherein,
when the path unit that the target mobile vehicle intends to travel and the path unit that the first mobile vehicle intends to travel are in the same direction, it is determined that the target mobile vehicle and the first mobile vehicle have the forward conflict,
adjusting the entry time point s1 of the target mobile vehicle to an adjusted entry time point s1′, AT4=s1′−s1=abs(e2−s1)+TT,
where e2 is an exit time point of the first mobile vehicle from the path unit, abs(e2−s1) represents an absolute value of (e2−s1), and TT is a tolerance time,
the transportation cost of the target mobile vehicle is AT4*V+D, where V represents a speed of the target mobile vehicle, and D represents a distance between two nodes.

19. The multi-mobile vehicle control system according to claim 17, wherein,
when the path unit that the target mobile vehicle intends to travel and a second path unit that the first mobile vehicle intends to travel reach the same connection point, it is determined that the target mobile vehicle and the first mobile vehicle have the cross conflict,
adjusting the entry time point s1 of the target mobile vehicle to an adjusted entry time point s1′, AT5=s1′−s1=abs(e2−s1)+TT, abs(e2−s1) represents an absolute value of (e2−s1), and TT is a tolerance time,
the transportation cost of the target mobile vehicle is AT5*V+D, where V represents a speed of the target mobile vehicle, and D represents a distance between two nodes.

20. The multi-mobile vehicle control system according to claim 17, wherein,
when the path unit that the target mobile vehicle intends to travel and the path unit that the first mobile vehicle intends to travel are in opposite directions, it is determined that the target mobile vehicle and the first mobile vehicle have the head-on conflict,
when the head-on conflict occurs, an adjustment time for the target mobile vehicle makes the transportation cost for traveling the path unit higher than the transportation cost for traveling an adjacent path unit.

21. The multi-mobile vehicle control system according to claim 17, wherein,
when it is determined that there is no conflict between the target mobile vehicle and the first mobile vehicle, an adjusted transportation cost of the target mobile vehicle is related to a distance between two nodes.

22. The multi-mobile vehicle control system according to claim 17, wherein in performing traffic path movement of multi-mobile vehicles, the control unit or the mobile vehicles are configured for:
updating an actual exit time of a mobile vehicle from a current path unit, and compensating a time difference between the actual exit time and a planned exit time in a scheduled path timing of the mobile vehicle in a path server;
determining whether there is a multi-mobile vehicle conflict or a path unit occupancy conflict with the at least other mobile vehicle in the scheduled path timing of the mobile vehicle;
replanning the path unit where the multi-mobile vehicle conflict or the path unit occupancy conflict occurs; and
controlling the mobile vehicle to move along a planned path to a target node.

23. The multi-mobile vehicle control system according to claim 22, wherein the path unit occupancy conflict includes a forward conflict, a cross conflict, or a head-on conflict.

24. The multi-mobile vehicle control system according to claim 22, wherein, when the mobile vehicle starts to leave the current path unit:
when a conflict occurs in the current path unit after timing compensation, replanning the conflicted current path unit;
occupying a next path unit; and
releasing the current path unit, and updating data of the occupied next path unit and the released current path unit in the path server.

25. The multi-mobile vehicle control system according to claim 22, wherein, when the mobile vehicle starts to enter the current path unit:
releasing a previous path unit;
updating an actual entry time of the mobile vehicle into the current path unit, and compensating a time difference between the actual entry time and a planned entry time in a planned path schedule;
when a conflict occurs in the current path unit after timing compensation, replanning the conflicted current path unit; and
occupying the current path unit, and updating data of the released previous path unit and the occupied current path unit in the path server.
